(19) United States
(12) Patent Application Publication
(10) Pub. No.: US 2012/0138710 A1
(43) Pub. Date: Jun. 7, 2012

(54) Hybrid Variable Area Fuel Injector With Thermal Protection

(75) Inventors: Paul G. Hicks, Holland, MI (US); Robert J. Pederson, Thousand Oaks, CA (US)

(73) Assignees: Pratt & Whitney Rocketdyne Inc., Canoga Park, CA (US); Woodward FST, Inc., Rockford, IL (US)

(21) Appl. No.: 12/957,744

(22) Filed: Dec. 1, 2010

(51) Int. Cl. B05B 1/32

(52) U.S. Cl. 239/455

(57) ABSTRACT

A hybrid variable area fuel injector is provided. The fuel injector includes a main body portion and a head portion carried by the main body portion. The fuel injector defines a fixed area port provided by the head portion for use during low flow conditions. The fuel injector defines a variable area port for use during high flow conditions. The variable area port is provided between the main body portion and the head portion. The area of the variable area port is adjustable due to the position of the head portion relative to the main body portion. The fuel injector also includes a shield portion surrounding at least a portion of the head portion. The shield portion reduces the amount of cross-flow that impinges on the head portion to reduce heat transfer to the head portion.

### FIELD OF THE INVENTION

This invention generally relates to fuel injectors and more particularly to variable area fuel injectors.

### BACKGROUND OF THE INVENTION

Variable area fuel injectors (VAFI's) have been extensively used in ramjet applications, such as high speed missiles, and are extremely useful for realizing high performing ramjet engines. This is because they provide the necessary large fuel turn-down ratios (FTDR—max to min fuel flow rates) and improved spray characteristics required for ramjet takeover after booster launch, high altitude cruise and powered dive/on-the-deck run-in capability. As a result of having a large FTDR, VAFI's also allow minimizing the number of standard fuel injectors (i.e., orifice or simplex), fuel valves, manifolds, as well as, improvement in ramjet performance and the ability to reduce overall fuel system cost and risk.

The use of VAFI's provides the benefit of good atomization over a much wider range of fuel flow rates. Also, the fuel pressure drop is taken at the fuel injection location, thus providing additional atomization benefits over traditional pressure-swirl and plain-orifice atomizers.

However, due to manufacturing variations, at low pressures flow rates and fluid distribution near the cracking pressure of the nozzle are inconsistent. In addition, fuel distribution is degraded due to the uneven lifting of the central pintle. Thus, at high flow rates, the injector will perform well, but at lower flow rates, flow can be very inconsistent and atomization quality reduced.

These challenges have lead to the development of a hybrid variable area fuel injector (HVAFI). This injector uses a simplex pilot for lower flow rates and uses the variable area portion of the injector to achieve the higher flow rates.

However, in many applications, the HVAFI could be inserted into the inlet flow and subject to a cross-flow such that the tip of the simplex pilot can subjected to high-velocity air with elevated temperatures. These temperatures, although good for atomization, can cause the tip to clog due to thermally-induced coking In certain applications, such as ramjet missiles or ramjet lift thrust nozzles, the pilot is used through most of the operation of the ramjet engine (the main is used only during a brief period). Thus, failure of the simplex tip due to coking can result in potential degradation in combustion efficiency and reduced effectiveness in enabling the ramjet propulsion engine to meet its overall flight mission objectives.

### BRIEF SUMMARY OF THE INVENTION

A hybrid variable area fuel injector is provided. The fuel injector includes a main body portion and a head portion carried by the main body portion. The fuel injector defines a fixed area port provided by the head portion for use during low flow conditions. The fuel injector defines a variable area port for use during high flow conditions. The variable area port is provided between the main body portion and the head portion. The area of the variable area port is adjustable due to the position of the head portion relative to the main body portion. The fuel injector also includes a shield portion surrounding at least a portion of the head portion. The shield portion reduces the amount of cross-flow that impinges on the head portion to reduce heat transfer to the head portion.

The tip (i.e. head portion) may include a thermal barrier coating (TBC) for increased thermal protection. Further, this tip could take the form of a simplex pilot or any other atomizer.

In one embodiment, the shield portion is formed by the main body portion into a single continuous component. In other words, the shield portion is not a separate component otherwise attached to the main body such as by welding or other attachment means.

An annular chamber is formed between the shield portion and the head portion. This annular chamber provides a thermal buffer between the shield portion and the head portion to reduce the heat transfer to the head portion. However, in other embodiments, it could cover 100 percent.

In one embodiment, the annular chamber surrounds at least 40 percent of the axial length of the head portion. In other embodiments, the annular chamber surrounds at least 50, 60 or 70 percent of the axial length of the head portion.

In more particular embodiments, the annular chamber surrounds at least 40 percent of the axial length of a portion of the head portion that does not form the variable area port. Thus, the annular chamber surrounds the portion of the head portion that is downstream from the variable area port.

In one embodiment, the head portion includes a conical surface that mates with a corresponding conical surface of the main body portion to provide the variable area port therebetween. The annular chamber is downstream from the mating location of these two surfaces.

In one embodiment, at least a portion of the annular chamber is formed between an inner conical surface of the shield portion and an outer cylindrical surface of the head portion.

In one embodiment, the head portion is formed in part by a simplex pilot attached to a pintle, the simplex pilot providing the fixed area port.

In one embodiment, the variable area port is provided between the pintle portion of the head portion.

In one embodiment, a distal end of the head portion is axially offset from a distal end of the shield portion and is axially unprotected by the shield portion. This provides the distal end of the head portion directly in a cross-flow air flow within the combustor.

In some embodiments, the inner annular surface of the shield portion has an angle of between about 30 degrees and 90 degrees. Preferably, the angle is less than 90 degrees as such an angled surface allows for the spray of fuel from the variable area port to expand prior to being injected into the air flow. This expansion improves atomization.

In one embodiment, the fuel injector further includes a dampening system acting on the pintle and biasing the head portion toward the main body to bias the variable area port towards a closed state. The dampening system dampens fluctuations in the position of the head portion relative to the main body portion due to fluctuations in fuel pressure.

In one embodiment, the shield portion surrounds between at least 50 percent of the head portion. However, it is preferred that less than 90 percent be unsurrounded, which allows at least the distal end portion of the head portion to be located within the cross-flow.

In one embodiment, the pintle has a necked down portion that passes through a narrow throat of the main body portion. The pintle includes a hollow cavity that has an inlet through a sidewall of the pintle upstream of the throat. The hollow cavity fluidly communicates the inlet with the fixed area port.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective illustration of a hybrid variable area fuel injector according to an embodiment of the present invention.

FIG. 2 is a cross-section of the fuel injector of FIG. 1 in a low flow state;

FIG. 3 is a cross-section of the fuel injector of FIG. 2 in a high flow state;

FIG. 4 is a partial enlarged cross-section of the fuel injector of FIG. 2 in the low flow state; and

FIG. 5 is an illustration of a prior art hybrid variable area fuel injector.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

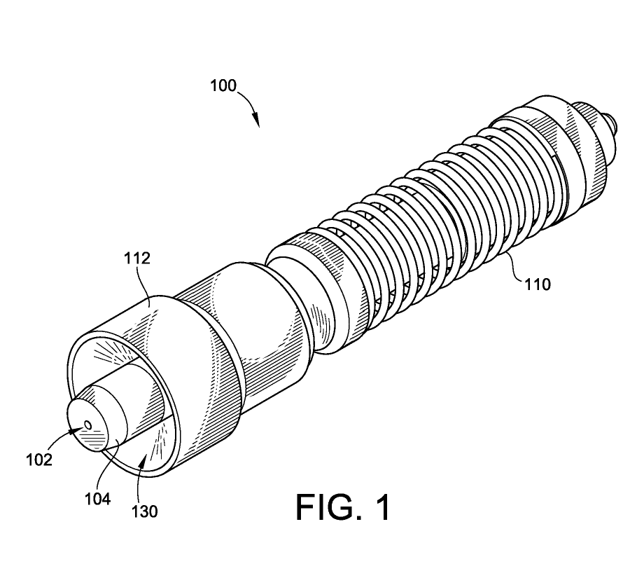

FIG. 1 is a perspective illustration of a hybrid variable area fuel injector 100 (injector 100) according to an embodiment of the present invention. The injector 100 is used to meter and inject fuel into a combustor of an engine. As will be described, the injector 100 is a hybrid because it operates with a fixed area port during low flow and high flow operations and a variable area port only during high flow operations. This allows the injector 100 to handle the less consistent fuel flow characteristics at low flow conditions while still being able to provide the variable area port during high flow conditions.

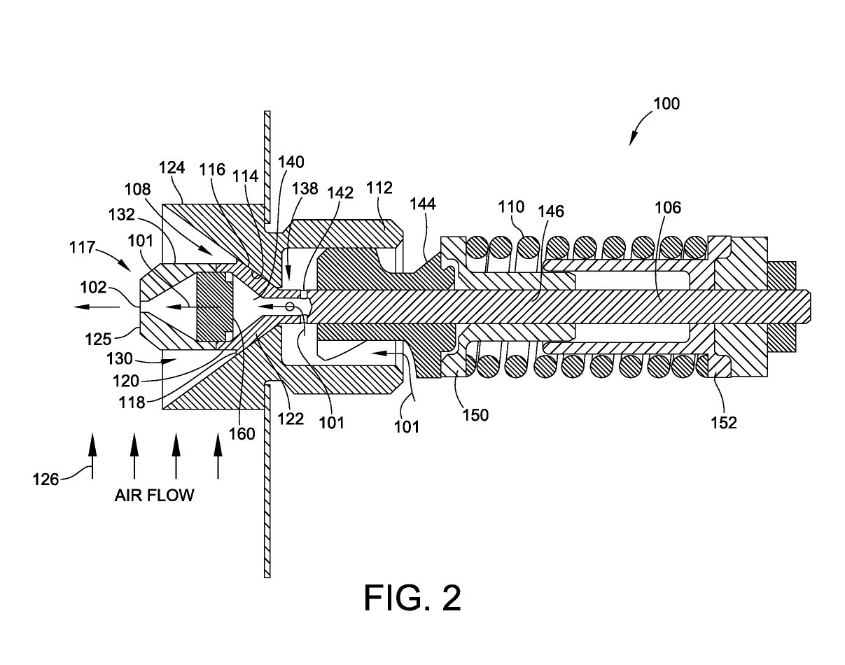

FIG. 2 illustrates the injector 100 in cross-section in a low flow condition during which fuel 101 (illustrated as arrows 101) will flow through fixed area port 102. The fixed area port 102 is provided by simplex pilot 104 (pilot 104). However, not all designs need be a simplex pilot. As such during low flow operations, the size of the port through which the fuel is dispensed from injector 100 remains fixed.

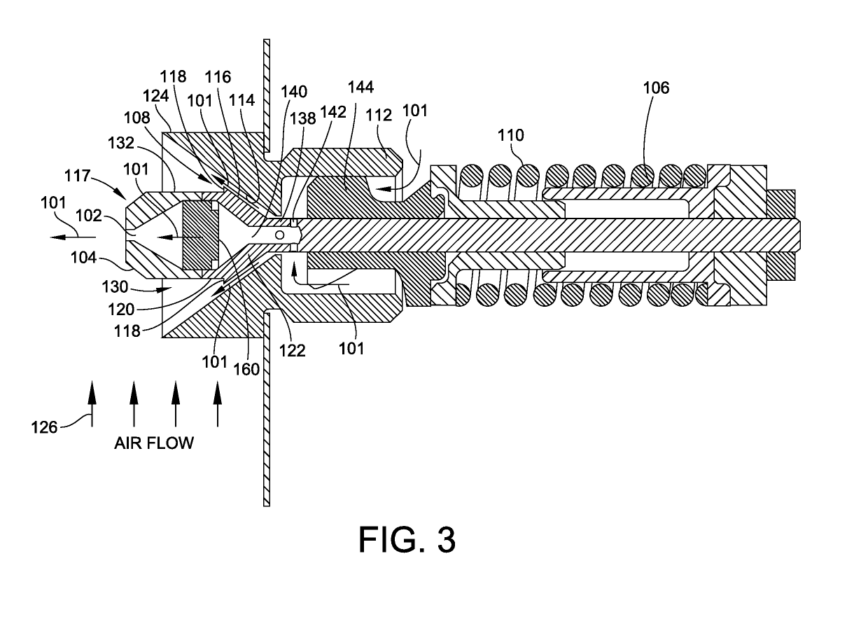

During high flow conditions (as illustrated in FIG. 3), the pressure of fuel 101 causes pintle 106 to move and open variable area port 108. More particularly, the pressure of the fuel 101 overcomes and acts against the force generated by compression spring 110 to meter the area of variable area port 108. Thus to increase the port area for variable area port 108, pressure of fuel 101 is increased.

The pressure at which pintle 106 will move relative to main body 112 of the injector 100 is referred to as the “cracking pressure.”

In the illustrated embodiment, the variable area port 108 is provided between mating cooperating conical surface 114 of the main body 112 and mating cooperating conical surface 116 of head portion 117. As the area between the mating surfaces 114, 116 increases, so does the size of the port 108 to increase the amount of fuel flow therethrough.

Conical surface 116 includes a fuel detachment flange 118 that prevents fuel from sticking to head portion 117 due to surface tension. This ensures that fuel flows along conical surface 114 to exit main body 112 (FIG. 2) rather than sticking to head portion 117. In this embodiment, the fuel detachment flange 118 forms a step adjacent a cylindrical outer surface portion 120 of head portion 117. In the illustrated embodiment, the step is formed by a surface that extends radially inward from the tip of detachment flange 118 toward a conical surface of head portion 117. This portion of head portion 117 is formed by a conical portion 122 of pintle 106. This conical portion 122 of pintle 106 flares radially outward in the direction of fuel flow through injector 100.

The stepped profile provided by fuel detachment flange 118 allows the fuel to detach from head portion 117. The diameter of head portion 117 is maximum at the tip of fuel detachment flange 118 and then reduces downstream thereof.

As fuel pressure increases due to a call for a greater amount of fuel to be injected into the combustor of the engine, the fuel pressure will act on the head portion 117 causing the head portion 117 to translate relative to main body 112 and open variable area port 108. Thus, pintle 106 will be driven relative to main body 112 in the direction of the fuel flow once the cracking pressure of the fuel 101 has been reached.

In the illustrated embodiment, the head portion 117 is provided in part by simplex pilot 104 as well as the conical portion 122 of pintle 106. In alternative embodiments, it is possible for the head portion 117, including the simplex pilot 104 and conical portion 122 of pintle 106, to be formed as a single one-piece construction (i.e. formed from a single continuous piece of material such as by molding or machining from a single piece of material).

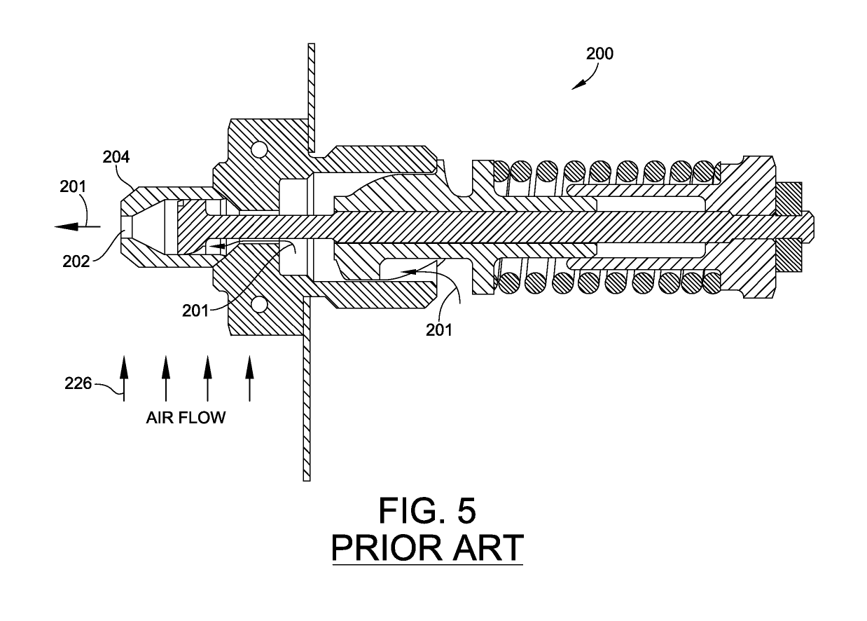

As noted above and with reference to FIG. 5, prior art injectors 200 included a simplex pilot 204 that was substantially entirely exposed to high temperature air cross-flow 226 (illustrated as arrows 226). This high temperature air cross-flow caused coking of the fuel flow 201 which would degrade the operability of fixed area port 202 during low flow conditions.

Returning to FIGS. 2 and 3, the illustrated embodiment of injector 100 includes a shield portion 124 that protects head portion 117 and particularly simplex pilot 104 from the high-temperature air cross-flow 126. Rather than having a significant portion of the outer surface are of simplex pilot 104 exposed to direct impingement by the air cross-flow 126, the shield portion 124 protects the simplex pilot 104 from the air cross-flow 126. This increased protection of the simplex pilot 104 from direct impingement or exposure to the cross-flow 126 reduces heat transfer to head portion 117 to reduce coking.

In the illustrated embodiment, an annular chamber 130 is formed between the shield portion 124 of main body 112 and head portion 117. At least a portion of the annular chamber 130 is formed between main body 112 and at least a portion of simplex pilot 104 and more particularly between a portion of inner surface 114 of main body 112 and an outer surface 132 of simplex pilot 104. The annular chamber 130 forms an exit cone. At least a portion of annular chamber 130 surrounds a downstream portion of head portion 117. The downstream portion being the portion of the head portion 117 that is downstream from the seal formed by the head portion 117 and the main body 112 during low flow conditions when the variable area port 108 is in a closed state. It is this downstream portion of the head portion 117 that is desired to be protected from the cross flow 126 to avoid heating thereof.

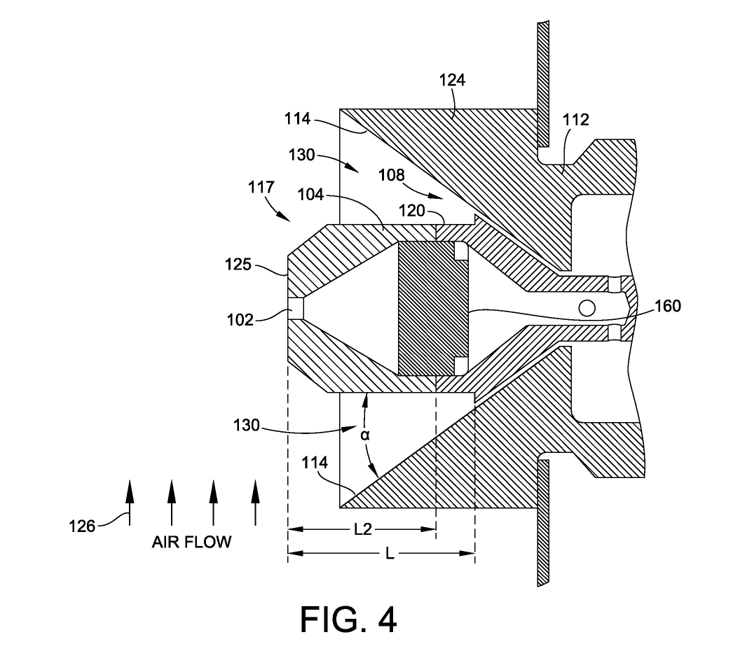

With reference to FIG. 4, the shield portion 124 preferably protects, in the low flow state, by axially overlapping therewith, at least 40 percent of the length L of the head portion 117 that does not form the variable area port 108 (i.e. the portion surrounded by annular chamber 130), more preferably at least 50 percent of the length L, more preferably at least 60 percent of the length L, more preferably at least 60 percent of the length L, and even more preferably at least 70 percent of the length L.

Further, the shield portion 124 preferably protects, in the low flow state, by axially overlapping therewith, at least 40 percent of the length L2 of the simplex pilot 104, more preferably at least 50 percent of the length L2, more preferably at least 60 percent of the length L2, more preferably at least 60 percent of the length L2, and even more preferably at least 70 percent of the length L2.

The addition of the annular chamber 130 (i.e. exit cone) allows the fuel stream to spread out in a larger radius prior to being injected into the air stream provided by cross-flow 126. This allows for increased atomization of the main flow during high flow conditions. Thus, shield 124 provides both improved operation during low flow conditions by preventing coking while injecting fuel through fixed area port 102 and increasing atomization when using variable area port 108 during high flow operations.

Further, some of the fuel during high flow operation will contact and flow along conical surface 114 of main body 112. This will increase fuel temperature due to contact therewith. This increase in fuel temperature reduces liquid viscosity and is expected to increase atomization quality prior to injecting the fuel into cross-flow 126. Similarly, the heating of the fuel will also lead to cooling of the main body 112. This further reduces the chance that the fuel within the head portion 117 will coke. The fuel on conical surface 114 will also act as a further radiation shield to further insulate the injector 100.

As the fuel will increase in temperature, this will improve volatility and improve vaporization. This will improve combustion efficiency and thus the range of the ramjet missile.

In preferred embodiments, at least the distal end 125 of head portion 117 axially extends beyond shield portion 124 during low flow conditions (see FIG. 2). This allows the fuel exiting fixed area port 102 to be more uniformly mixed with cross-flow 126. However, in other embodiments, the simplex pilot 104 could be entirely hidden within shield portion 124 during the low flow condition (e.g. FIG. 2).

Conical surface 114 preferably extends at an angle α of between about 30 and 60 degrees relative to a central axis of injector 100. The angle α is more preferably between about 40 and 50 degrees relative to the central axis of the injector. However, the angle α can vary depending on desired spray angle.

The fuel detachment flange 118 has a stepped surface that is generally perpendicular to the axial length of the injector 100. In the illustrated embodiment, this stepped surface makes an angle with conical surface 116 of 90 degrees minus angle x.

In other embodiments, the stepped surface that steps radially inward to other embodiments, the stepped surface that steps radially inward to cylindrical surface 120 need not be perpendicular to cylindrical surface 120. It is preferred that the tip of fuel detachment flange 118 forms the maximum diameter for head portion 117. Further, the tip preferably has angle defined by conical surface 116 and the stepped surface of no greater than 90 degrees and more preferably no greater than 60 degrees, and more preferably no greater than 45 degrees. The sharper this angle, the better detachment between the fuel and conical surface 116.

The use of the main body 112 to form the shield portion 124 allows for the thermal protection without increasing the number of components for the injector 100.

The pintle 106 includes a necked down region 138 that passes through main body 112. Preferably, this necked down region 138 does not seal on the aperture of the main body 112 through which it passes. Because the necked down region 138 does not seal on the aperture, the pintle 106 does not prevent fuel from flowing through the aperture such that it is permitted to act on conical surface 116 during low flow and high flow conditions.

Further, in some embodiments, such as illustrated in FIG. 2, the pintle 106 includes a hollow section 140 through which fuel enters and passes during, at least, the low flow operations. The fuel enters the hollow section 140 through apertures 142. These apertures are formed in necked own region 138. The hollow section 140 connects inlets, i.e. apertures 142, with fixed area port 102. The inlets, i.e. apertures, pass radially through a sidewall of pintle 106. This hollow section 140 passes through a narrowed throat region of main body 112.

In alternative arrangements, hollow section 140 could extend the entire length of pintle 106 and exit at the end thereof rather than through a side. Further yet, holes could be formed through the conical surface 116 to allow for low pressure flow through pilot 104.

The injector 100 includes a swirling guide element 144 configured to cause fuel 101 to swirl as it approaches head portion 117. The swirling guide element 144 also slidably guides the shaft 146 of pintle 106. The swirling guide element could be formed from one single piece or a plurality of pieces.

A fuel swirler 160 is positioned within head portion 117. This fuel swirler 160 further promotes atomization of the fuel passing through head portion 117. This fuel swirler 160 could be formed from one single piece or a plurality of pieces.

The injector 100 also includes a dampening system that includes spring 110 and a pair of guides 150, 152. The spring 110 acts between the pair of guides 150, 152 and acts to bias the two guides 150, 152 away from one another. In doing so, the spring 110 acts to bias pintle 106 in a direction directing head portion 117 into contact toward main body 112. This dampening system helps dampen fluctuations in the position of pintle 106 due to fluctuations in fuel pressure and environmental pressure.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A hybrid variable area fuel injector comprising:
a main body portion;
a head portion carried by the main body portion;
a fixed area port provided by the head portion;
a variable area port provided between the main body portion and the head portion, the area of the variable area port adjustable due to the position of the head portion relative to the main body portion; and
a shield portion surrounding at least a portion of the head portion.

2. The fuel injector of claim 1, wherein the shield portion is formed by the main body portion into a single continuous component.

3. The fuel injector of claim 1, wherein an annular chamber is formed between the shield portion and the head portion.

4. The fuel injector of claim 3, wherein the annular chamber surrounds at least 40 percent of the axial length of the head portion.

5. The fuel injector of claim 3, wherein the annular chamber surrounds at least 40 percent of the axial length of a portion of the head portion that does not form the variable area port.

6. The fuel injector of claim 5, wherein the head portion includes a conical surface that mates with a corresponding conical surface of the main body portion to provide the variable area port therebetween.

7. The fuel injector of claim 6, wherein the annular chamber is downstream from the variable area port.

8. The fuel injector of claim 3, wherein at least a portion of the annular chamber is formed between an inner conical surface of the shield portion and an outer cylindrical surface of the head portion.

9. The fuel injector of claim 1, wherein the head portion is formed in part by a simplex pilot attached to a pintle, the simplex pilot providing the fixed area port.

10. The fuel injector of claim 9, wherein the variable area port is provided between the pintle portion of the head.

11. The fuel injector of claim 3, wherein the distal end of the head portion is axially offset from a distal end of the shield portion and is axially unprotected by the shield portion.

12. The fuel injector of claim 8, wherein the inner annular surface has an angle of between about 30 degrees and 60 degrees.

13. The fuel injector of claim 9, wherein the head portion includes a cylindrical portion spaced radially inward from the shield portion.

14. The fuel injector of claim 13, wherein the cylindrical portion is provided in part by the simplex pilot and in part by the pintle.

15. The fuel injector of claim 9, further comprising a dampening system acting on the pintle and biasing the head portion toward the main body to bias the variable area port towards a closed state.

16. The fuel injector of claim 1, wherein shield portion surrounds between about 50 percent and 100 percent of the head portion.

17. The fuel injector of claim 16, wherein a distal end of the head portion is axially offset from a distal end of the shield portion and not surrounded by the shield portion.

18. The fuel injector of claim 9, wherein the pintle has a necked down portion that passes through a narrow throat of the main body, the pintle including a hollow cavity that has an inlet through a sidewall of the pintle upstream of the throat, the hollow cavity fluidly communicating the inlet with the fixed area port.

19. A variable area injector comprising:
a main body portion providing a first conical surface;
a head portion movable relative to the main body and having a second conical surface;
a variable area port provided between the first and second conical surfaces, the first and second conical surfaces mating in a first state, the first and second conical surfaces spaced apart from one another in a second state to permit fuel flow therethrough; and
wherein the second conical surface terminates at a radially inward step forming a fuel detachment flange.

20. The variable area injector of claim 19, wherein the head portion has a maximum diameter at a downstream tip of the fuel detachment flange.

21. The variable area injector of claim 19, wherein the head portion has a cylindrical surface downstream from the second conical surface,

22. The variable area injector of claim 21, wherein the head portion includes a stepped surface extending radially inward from the second conical surface to the cylindrical surface.

23. The variable area injector of claim 22, wherein the stepped surface and the conical surface form an angle of no greater than 90 degrees.

24. The variable area injector of claim 22, wherein the stepped surface and the conical surface form an angle of no greater than 60 degrees.
